(19) United States
(12) Patent Application Publication
(10) Pub. No.: US 2011/0249040 A1
(43) Pub. Date: Oct. 13, 2011

(54) COLOR SIGNAL PROCESSING APPARATUS AND COLOR SIGNAL PROCESSING METHOD

(75) Inventor: Yukio Hiraki, Atsugi-shi (JP)

(73) Assignee: CANON KABUSHIKI KAISHA, Tokyo (JP)

(21) Appl. No.: 13/081,440

(22) Filed: Apr. 6, 2011

(30) Foreign Application Priority Data
Apr. 13, 2010 (JP) 2010-092540

(51) Int. Cl. G09G 5/10

(52) U.S. Cl. 345/690

(57) ABSTRACT

A color signal processing apparatus which performs a linear matrix transformation includes: an approximate coefficient storage unit that stores approximate coefficients of approximate expressions, which approximate values of the matrix coefficients, respectively, and in which a value of a first color among three primary colors of RGB is made a variable, a matrix coefficient calculation unit that calculates 3×3 matrix coefficients according to an input RGB signal by substituting a value of the first color in the input RGB signal for the approximate expressions given by the approximate coefficients readout from the approximate coefficient storage unit; and a conversion unit that performs color conversion by multiplying the input RGB signal by the matrix coefficients calculated by the matrix coefficient calculation unit, and outputs color-converted RGB signal.

### BACKGROUND OF THE INVENTION

1. Field of the Invention

The present invention relates to a technique of applying color conversion by a linear matrix transformation to an RGB signal.

2. Description of the Related Art

In image display devices such as TV devices, display devices, etc., chromaticity points of primary colors (RGB) that are actually displayed are usually different to the chromaticity points specified by standards such as the NTSC system. A linear matrix transformation is used as a simple method for correcting this.

Now, suppose that there are a first device and a second device in which the CIE-XYZ chromaticities of respective RGB primary colors are as follows.

For the first device, R: (Xr, Yr, Zr), G: (Xg, Yg, Zg), and B: (Xb, Yb, Zb).

For the second device, R: (Xr′, Yr′, Zr′), G: (Xg′, Yg′, Zg′), B: (Xb′, Yb′, Zb′).

The chromaticity (X, Y, Z) of luminance signal values (R, G, B) according to the first device can be represented by the following equation 1, and the chromaticity (X′, Y′, Z′) of luminance signal values (R′, G′, B′) according to the second device can be represented by the following equation 2.

$$\begin{matrix}( \begin{matrix}X \\ Y \\ Z\end{matrix} ) = ( \begin{matrix}Xr & Xg & Xb \\ Yr & Yg & Yb \\ Zr & Zg & Zb\end{matrix} ) ( \begin{matrix}R \\ G \\ B\end{matrix} ) & ( 1 ) \\ ( \begin{matrix}{X}^{′} \\ {Y}^{′} \\ {Z}^{′}\end{matrix} ) = ( \begin{matrix}{Xr}^{′} & {Xg}^{′} & {Xb}^{′} \\ {Yr}^{′} & {Yg}^{′} & {Yb}^{′} \\ {Zr}^{′} & {Zg}^{′} & {Zb}^{′}\end{matrix} ) ( \begin{matrix}{R}^{′} \\ {G}^{′} \\ {B}^{′}\end{matrix} ) & ( 2 )\end{matrix}$$

Here, in order to make the chromaticity (X′, Y′, Z′) of the second device equal to the chromaticity (X, Y, Z) of the first device, the luminance signal values R′, G′, B′, which have been subjected to a 3×3 linear matrix transformation by the following equation 3, need only be supplied to the second device.

$$\begin{matrix}( \begin{matrix}{R}^{′} \\ {G}^{′} \\ {B}^{′}\end{matrix} ) = ( \begin{matrix}Rr & Rg & Rb \\ Gr & Gg & Gb \\ Br & Bg & Bb\end{matrix} ) ( \begin{matrix}R \\ G \\ B\end{matrix} ) \\ where & ( 3 ) \\ ( \begin{matrix}Rr & Rg & Rb \\ Gr & Gg & Gb \\ Br & Bg & Bb\end{matrix} ) = {( \begin{matrix}{Xr}^{′} & {Xg}^{′} & {Xb}^{′} \\ {Yr}^{′} & {Yg}^{′} & {Yb}^{′} \\ {Zr}^{′} & {Zg}^{′} & {Zb}^{′}\end{matrix} )}^{- 1} \cdot ( \begin{matrix}Xr & Xg & Xb \\ Yr & Yg & Yb \\ Zr & Zg & Zb\end{matrix} ) & ( 4 )\end{matrix}$$

In Japanese patent application laid-open No. H05-068167, there is proposed a method of carrying out, in addition to equalization of color reproduction, image quality adjustment by means of this linear matrix transformation. This method controls color reproduction by calculating matrix coefficients of the linear matrix transformation (hereinafter simply referred to as “linear matrix coefficients”) by the use of individual controlled variables for the color level, contrast, brightness, and hue.

Such a linear matrix transformation is based on the premise that the chromaticity of each primary color is constant, without depending on the brightness thereof. In cases where this premise is not satisfied, in other words, when the chromaticity of a primary color changes, there occurs a case where the accuracy of color conversion may be decreased by a combination of the values of RGB.

As a technique to suppress the chromaticity change of each primary color, there has been known a method that is described in Japanese patent application laid-open No. 2005-354728. Specifically, in the Japanese patent application laid-open No. 2005-354728, there is disclosed processing of adding an offset value calculated from the value of R of an input signal and an offset value calculated from the value of G thereof to the value of B thereof, in order to suppress the chromaticity changes of R and G.

In addition, in Japanese patent application laid-open No. H04-021191, there is proposed a method of performing color signal correction by the use of 3D-LUTs. This method is to achieve color conversion with high accuracy by using a three-dimensional color data conversion table corresponding to a combination of the values of RGB.

### SUMMARY OF THE INVENTION

FIG. 6 is a u′v′ chromaticity diagram (i.e., CIE 1976 UCS chromaticity diagram) showing the chromaticity change of each of RGB in a certain display device. Black rhombuses (♦) plot the chromaticity which was measured by changing a color signal value for each monochrome color of R, G, B. A triangle of broken lines connects chromaticities nearest to white among the chromaticities of the individual R, G, B colors, respectively. In addition, a triangle of solid lines represents an sRGB standard color gamut, and a mark x indicates a reference white D65.

As can be seen from FIG. 6, this display device has its color gamut different from the sRGB standard color gamut, so in order to correctly display the sRGB standard color gamut by means of this display device, it is necessary to correct the color signal values.

However, because the monochromatic chromaticity, in particular the chromaticity of B (blue), changes to a large extent, even if applying a simple linear matrix transformation as mentioned above, the accuracy of the color correction can not be expected. Nevertheless, if the method disclosed in the Japanese patent application laid-open No. 2005-354728 is applied so as to suppress the chromaticity change of B, the chromaticity of B will be adjusted to a chromaticity point of the lowest stimulus purity, and hence there is an adverse effect that a color reproduction range becomes narrow, thus making it impossible to reproduce the sRGB standard color gamut.

For this reason, in order to perform color correction of the display device having such a characteristic with high accuracy, in the past, 3D-LUTs as described in the Japanese patent application laid-open No. H04-021191 have to be used. But, such a scheme requires a huge amount of memory for storing tables, thus giving rise to a problem of high costs.

The present invention has been made in view of the aforementioned problems, and has for its object to provide a technique for performing color conversion with high accuracy while making use of the color reproduction range of a display device as much as possible.

The present invention in its first aspect provides a color signal processing apparatus which performs a linear matrix transformation, including: an approximate coefficient storage unit that stores approximate coefficients of approximate expressions, which approximate values of the matrix coefficients, respectively, and in which a value of a first color among three primary colors of RGB is made a variable, a matrix coefficient calculation unit that calculates 3×3 matrix coefficients according to an input RGB signal by substituting a value of the first color in the input RGB signal for the approximate expressions given by the approximate coefficients read out from the approximate coefficient storage unit; and a conversion unit that performs color conversion by multiplying the input RGB signal by the matrix coefficients calculated by the matrix coefficient calculation unit, and outputs color-converted RGB signal.

The present invention in its second aspect provides a color signal processing method which performs a linear matrix transformation, including the steps of: reading out approximate coefficients of approximate expressions, which approximate values of the matrix coefficients, respectively, and in which a value of a first color among three primary colors of RGB is made a variable, from an approximate coefficient storage unit that stores the approximate coefficients; calculating 3×3 matrix coefficients according to an input RGB signal by substituting a value of the first color in the input RGB signal for the approximate expressions given by the approximate coefficients read out; and performing color conversion by multiplying the input RGB signal by the calculated matrix coefficients, and to output color-converted RGB signal.

The present invention in its third aspect provides a non-transitory computer readable medium which stores a program for making a computer execute each step of the above-described color signal processing method.

According to the present invention, it is possible to carry out a highly accurate color conversion with the use of a small amount of memory while making use of the color reproduction range of a display device as much as possible.

Further features of the present invention will become apparent from the following description of exemplary embodiments with reference to the attached drawings.

### BRIEF DESCRIPTION OF THE DRAWINGS

FIG. 1 is a view showing the construction of a color signal processing apparatus of a first embodiment of the present invention.

FIG. 2 is a view showing a modified form of the first embodiment of the present invention.

FIG. 3 is a view showing the construction of a color signal processing apparatus of a second embodiment of the present invention.

FIG. 4 is a view showing the construction of a color signal processing apparatus of a fourth embodiment of the present invention.

FIG. 5 is a view showing the construction of an image display device.

FIG. 6 is a view explaining that the chromaticities of primary colors change in accordance with a color signal value.

FIG. 7 is a view showing the color signal value dependence of the chromaticity of a B primary color.

FIG. 8 is a view showing linear matrix coefficients calculated for each of color signal values.

FIG. 9 is a view showing an example in which linear matrix coefficients are approximated by third-order polynomials, respectively.

FIG. 10 is a view showing an example in which parts of the ranges of linear matrix coefficients are approximated by second-order polynomials, respectively.

### DESCRIPTION OF THE EMBODIMENTS

As a method for solving the above-mentioned problems, the present inventor has devised a method of applying a linear matrix transformation to a display device having a characteristic in which the chromaticities of primary colors change in accordance with the color signal values.

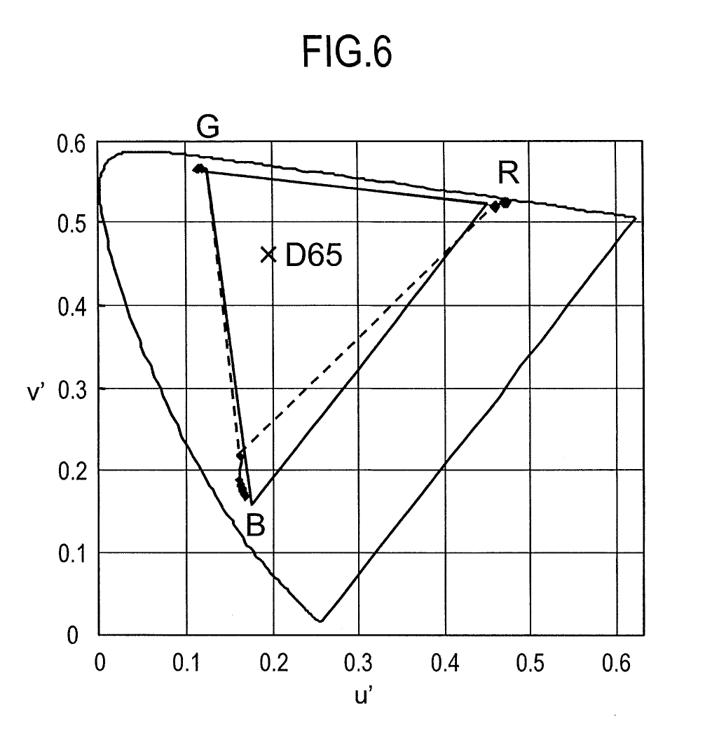

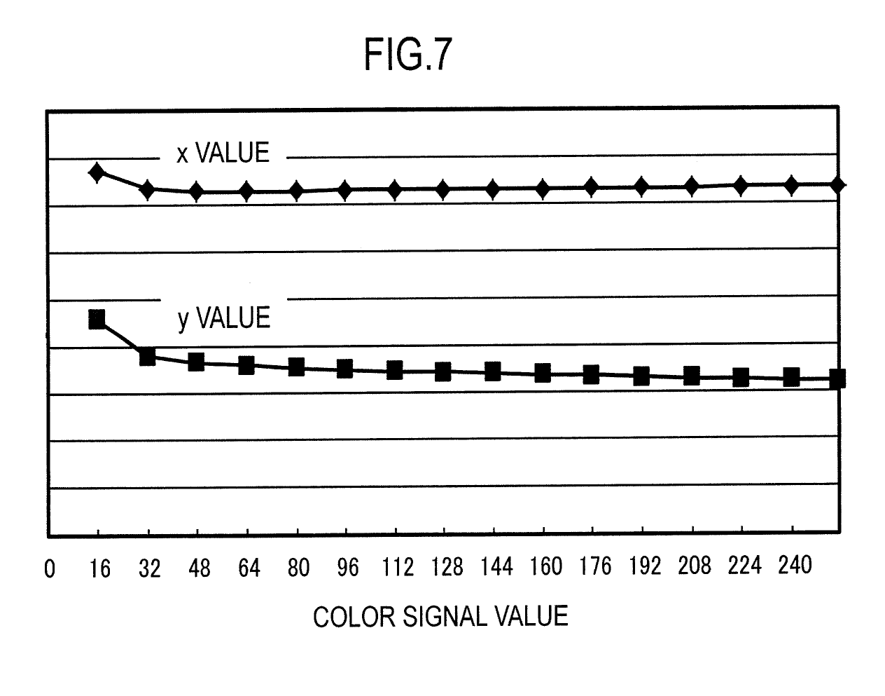

Now, reference will be made to a color signal processing method of the present invention by taking, as an example, a display device having a characteristic shown in FIG. 6. The reason for making quite difficult the application of a linear matrix transformation to the display device of FIG. 6 is that the chromaticity of a B primary color changes to a large extent with the change of the color signal value of B. FIG. 7 is a graph showing xy chromaticity values of the B monochromatic color signal of this display device, wherein the axis of abscissa represents the color signal value thereof, and the axis of ordinate represents the x value and the y value thereof. From FIG. 7, it is understood that the y value of the B primary color decreases in accordance with the increasing color signal value, and in particular, the rate of decrease is large in a region in which the color signal value is small.

The present inventor calculated linear matrix coefficients (matrix coefficients) for each color signal value, with respect to the B primary color which is large in its chromaticity change, by the use of the chromaticity coordinates of each color signal value. At this time, the chromaticity coordinates of a maximum color signal value were used with respect to an R primary color and a G primary color which are small in their chromaticity change. Then, as a result of using a plurality of linear matrix coefficients obtained in this manner, selecting linear matrix coefficients according to the value of B in an input RGB signal, and performing color signal processing, a color difference with respect to an ideal value was improved to a large extent, as compared with a conventional method using a single linear matrix coefficient. From this result, it was found that a method of changing linear matrix coefficients adaptively according to the value of a primary color with a large chromaticity change was preferable.

However, in this method, it is necessary to create and store a plurality of linear matrix coefficients which are equal to the number of values which the B primary color can take. For example, in the case of an 8-bit color signal, 256 kinds of linear matrix coefficients are needed, and in the case of a 10-bit color signal, 1024 kinds of linear matrix coefficients are needed. Therefore, there remains the problem that a lot of time is required to create tables of coefficients, and at the same time the amount of memory for storing such tables becomes very large, thus resulting in difficulty in implementing such a method on products.

The present inventor has conducted further investigation so as to solve this problem.

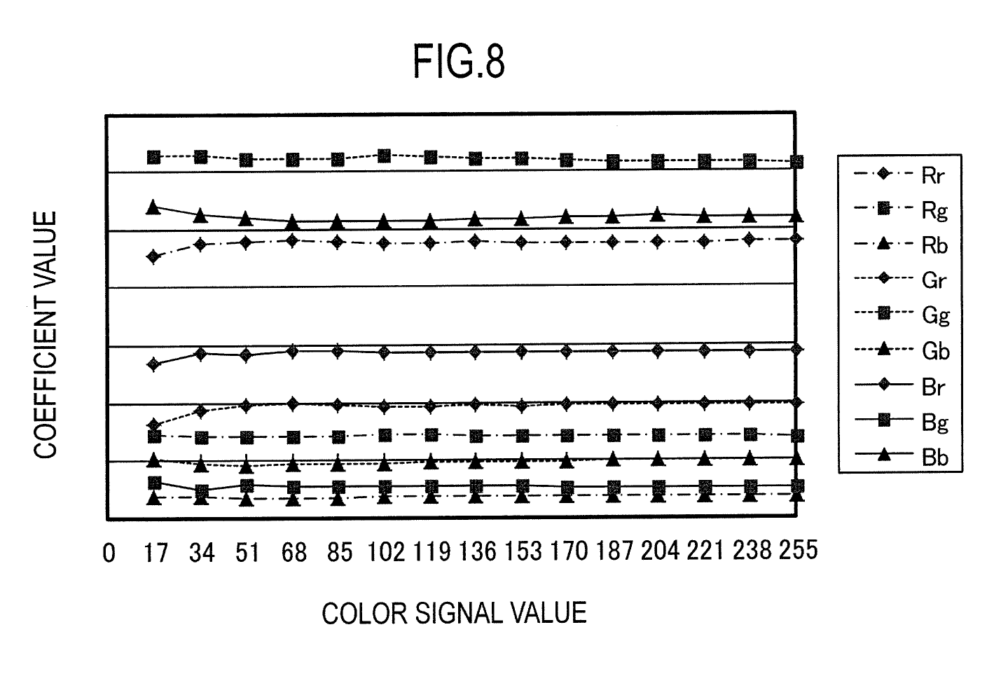

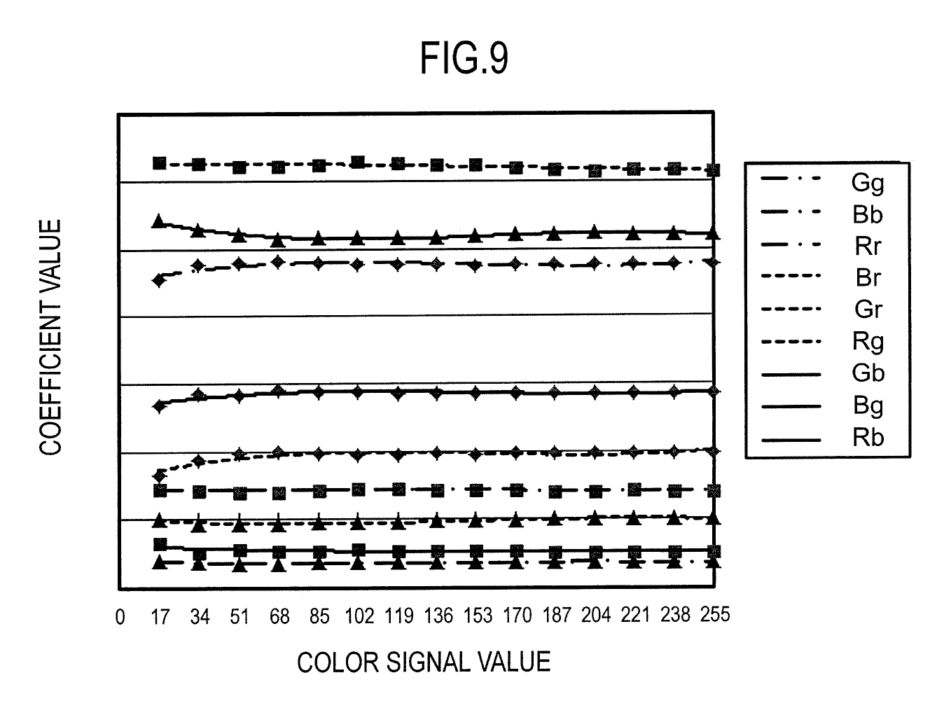

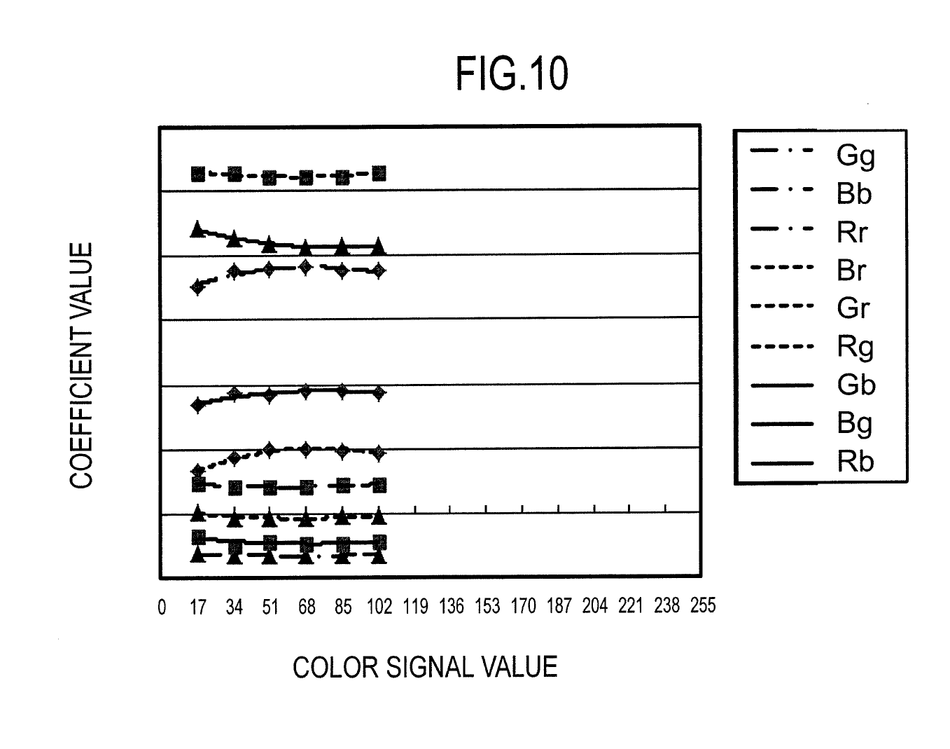

FIG. 8 plots the color signal value of the B primary color on the axis of abscissa, and nine pieces of linear matrix coefficients on the axis of ordinate. From this figure, it is found that in a dark part (a low luminance range), all the nine coefficients have large changes, but on the whole, minute changes with respect to the color signal value are small. Based on such an analysis, the present inventor had an idea that sufficient accuracy would also be obtained even by such a construction that each of the nine coefficients is approximated by a low-order polynomial, and a linear matrix coefficient is calculated from an approximate coefficient of each polynomial and the value of the B signal. FIG. 9 shows an example in which the value of each linear matrix coefficient in the entire range of the value of the B signal is approximated by a third-order polynomial. As a result of substituting the value of B of the input RGB signal for these polynomials, calculating the nine pieces of coefficients, and performing color signal processing with the use of the coefficients thus obtained, it was verified that color conversion accuracy at a level that is satisfactory in a practical sense was obtained. Moreover, focusing on that the change of each of the coefficients is large in a low luminance range of the value of the B signal, when polynomial approximations of only the coefficients in that region are carried out, it became clear that such approximations could be made to a sufficient extent even with the use of second-order polynomials, as shown in FIG. 10.

Here, note that the polynomials as referred to above are only some examples of suitable approximate expressions for the display device which the present inventor investigated. The kind and order of the approximate expressions need only be selected in an appropriate manner according to the characteristic of the display device. At this time, it is preferable to use approximate expressions of smaller computational complexity (i.e., polynomials of lower orders in the case of polynomial approximations). In addition, in the above-mentioned example, the approximate expressions each having the signal value of B as a variable were used, but in cases where it is desired to take the chromaticity change of R into consideration, approximate expressions each having the signal value of R as a variable should be used. Also, in cases where it is desired to take the chromaticity change of G into consideration, approximate expressions each having the signal value of G as a variable should be used.

(Image Display Device)

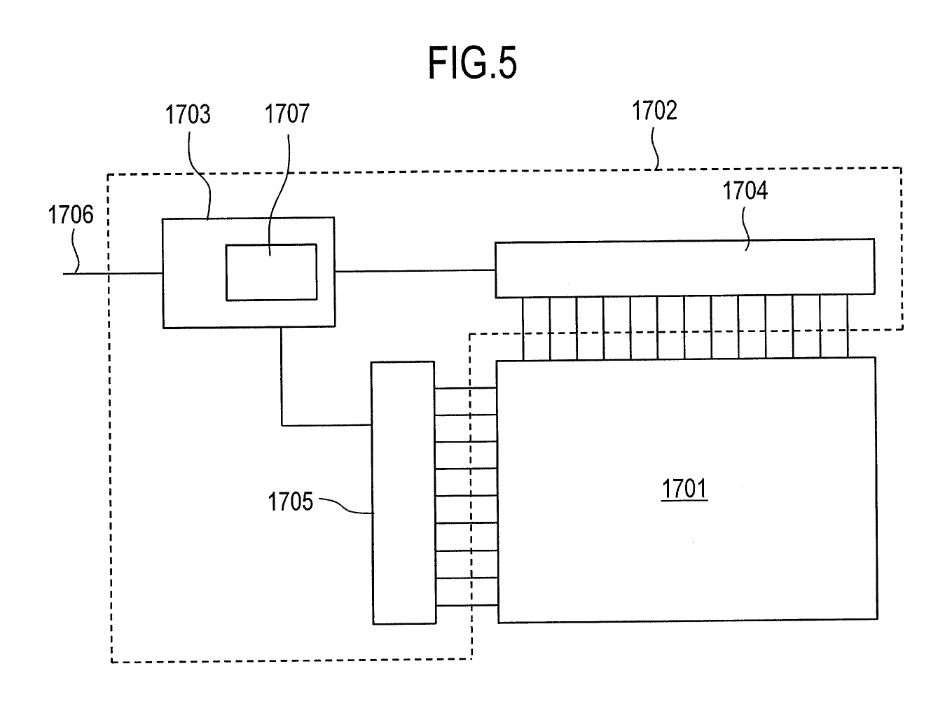

FIG. 5 shows an example of an image display device to which the present invention is applied. The image display device of this embodiment has a display panel 1701 and a drive circuit 1702.

The display panel 1701 is a flat display panel which has a plurality of display elements arranged in two dimensions. The display panel 1701 is provided with three kinds of display elements of red (R), green (G) and blue (B). Depending on a luminous body material (light emitting material) which is used for each color, etc., there appears the chromaticity change characteristic for each color, as shown in FIG. 6. As the display panel 1701, there can be used an electron beam display panel using cold cathode elements (electron emission elements) as electron sources, a liquid crystal display panel, a plasma display panel, an organic electroluminescence display panel, etc. Here, there is used the display panel 1701 which is provided with display elements composed of surface conduction type electron-emitting devices and fluorescent substances.

The drive circuit 1702 has a signal processing circuit 1703, a modulation signal output circuit 1704, and a scanning signal output circuit 1705. The modulation signal output circuit 1704 supplies a modulation signal to the display panel 1701. The scanning signal output circuit 1705 supplies a scanning signal to the display panel 1701. The signal processing circuit 1703 performs necessary processing on a video signal inputted through an input line 1706, and supplies a luminance signal and a timing signal to the modulation signal output circuit 1704 and the scanning signal output circuit 1705. The signal processing circuit 1703 has a color signal processing apparatus 1707 which performs the above-mentioned linear matrix transformation.

Hereinafter, detailed reference will be made to preferred embodiments of the color signal processing apparatus 1707. In addition, in the following description, an RGB signal on which gamma correction adjusted according to the characteristic of a CRT has been carried out is called a “RGB color signal”, and an RGB signal, which is obtained by applying inverse gamma correction to such a color signal so as to provide a linear characteristic with respect to brightness, is called a “RGB luminance signal”.

### First Embodiment

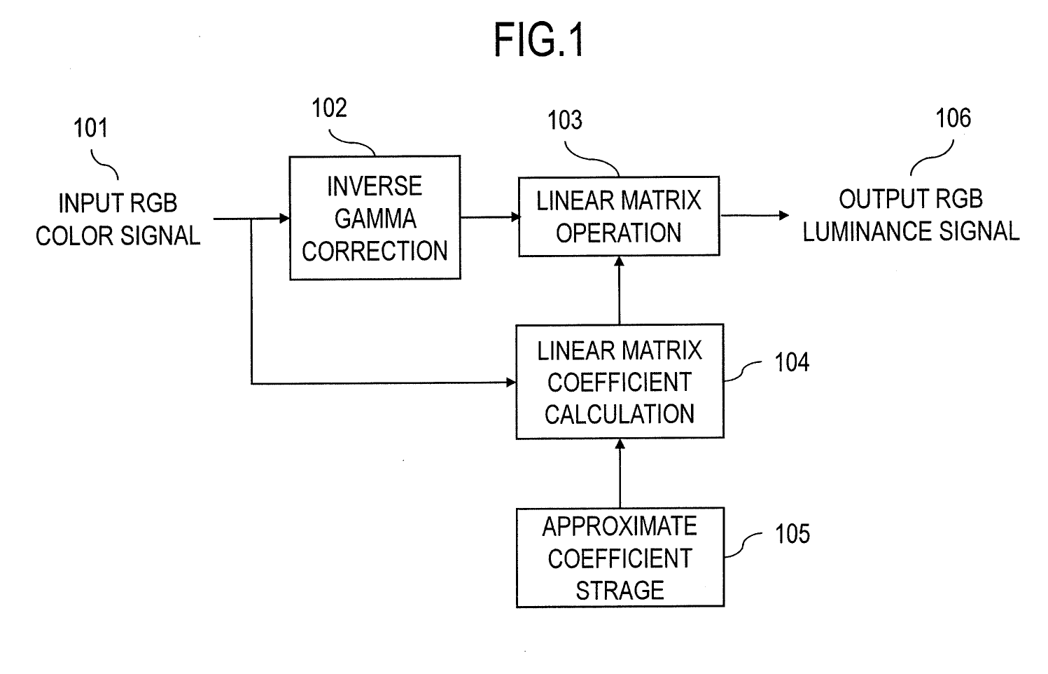

FIG. 1 is a block diagram showing the construction of a color signal processing apparatus of a first embodiment of the present invention. The color signal processing apparatus is provided with an inverse gamma correction unit 102, a linear matrix operation unit 103, a linear matrix coefficient calculation unit 104, and an approximate coefficient storage unit 105. In this embodiment, the linear matrix operation unit 103 corresponds to a conversion unit of the present invention, and the linear matrix coefficient calculation unit 104 corresponds to a matrix coefficient calculation unit of the present invention.

In the approximate coefficient storage unit 105, there is beforehand stored approximate coefficients of approximate expressions, which approximate values of linear matrix coefficients, respectively, and in which the value of one specific color (hereinafter referred to as the “specific color” or the “first color”) of three primary colors of RGB is made a variable. In this embodiment, blue (B) is selected as a specific color, and a third-order polynomial is used as an approximate expression. For example, Rr among nine pieces of linear matrix coefficients shown in the equation 3 is defined as shown in the following equation by the use of the value v of the B signal.

Rr=Rr0+Rr1×v+Rr2×v²+Rr3×v³,

where four elements, Rr0, Rr1, Rr2 and Rr3, are approximate coefficients for a linear matrix coefficient Rr. The values of these four approximate coefficients are stored in the approximate coefficient storage unit 105. The same is true of other linear matrix coefficients Rg, Rb, Gr, Gg, Gb, Br, Bg, Bb.

An input RGB color signal 101 is inputted to the color signal processing apparatus. This signal is transmitted to the inverse gamma correction unit 102, where it is subjected to well-known inverse gamma correction and is converted into an RGB luminance signal. In addition, the value of the B signal in the input RGB color signal 101 is also transmitted to the linear matrix coefficient calculation unit 104.

The linear matrix coefficient calculation unit 104 calculates 3×3 pieces of linear matrix coefficients according to the input RGB color signal 101, by reading out approximate coefficients from the approximate coefficient storage unit 105, and substituting the value of the B signal (the value of the first color) for the approximate expressions given by the approximate coefficients. The linear matrix coefficients thus calculated are transmitted to the linear matrix operation unit 103.

The linear matrix operation unit 103 performs color conversion by multiplying the RGB luminance signal by the linear matrix coefficients (see the equation 3), and output a color-converted output RGB luminance signal 106.

According to the construction described above, even in cases where the chromaticity of the specific color changes according to the brightness thereof, accurate color conversion can be carried out. In addition, a chromaticity point at each given brightness of the specific color can be used substantially as it is, so it is possible to carry out color conversion while taking the best advantage of the color reproduction range of the display device. Moreover, the amount of memory required for storing the coefficients is also very small. For example, even if one approximate coefficient is held as data of 4 bytes, the amount of memory required is only 144 bytes.

### Modification of First Embodiment

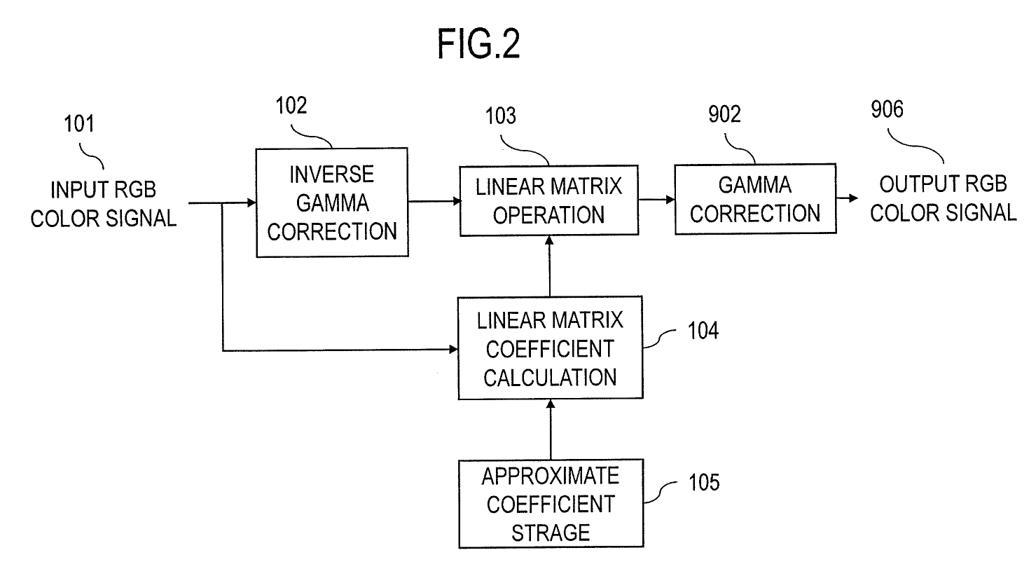

In the first embodiment of FIG. 1, the output is an RGB luminance signal, but as shown in FIG. 2, if a gamma correction unit 902 is arranged at a downstream stage or side of the linear matrix operation unit 103, it will also be possible to output an RGB color signal 906. In addition, in cases where an RGB luminance signal is inputted instead of an RGB color signal, the inverse gamma correction unit 102 in FIG. 1 and FIG. 2 is unnecessary. In this case, the coefficients to be stored in the approximate coefficient storage unit 105 need only be created based on the value of the RGB luminance signal. Here, note that in cases where both an RGB color signal and an RGB luminance signal are alternatively inputted, two kinds of approximate coefficients should be stored in the approximate coefficient storage unit 105, so that the approximate coefficients to be read out can be switched over therebetween according to the kind of the signal inputted.

### Second Embodiment

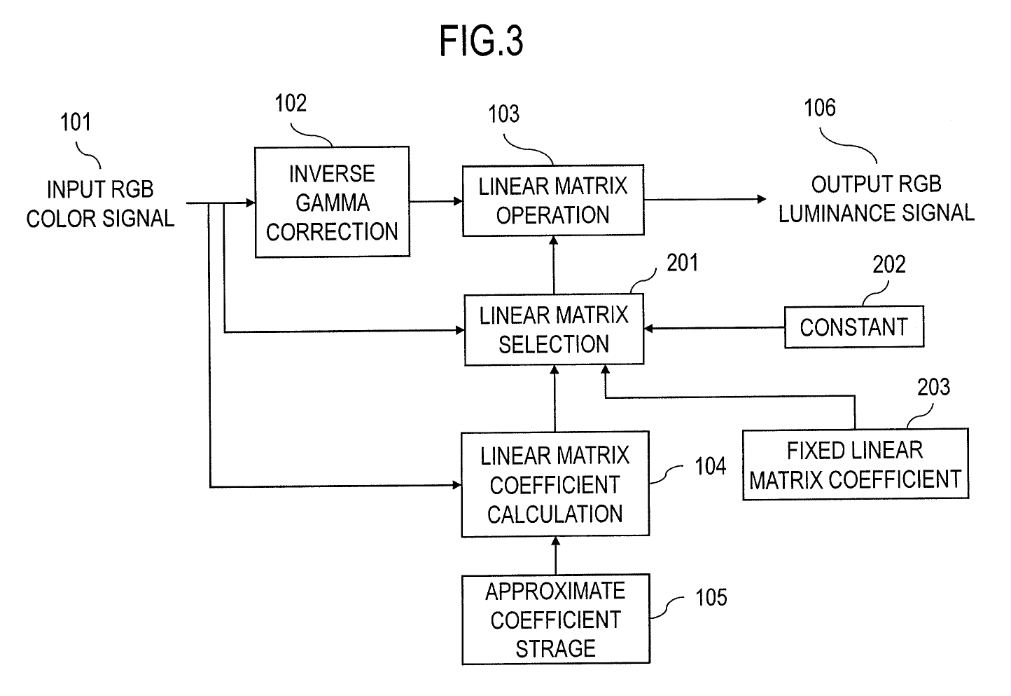

FIG. 3 is a block diagram showing the construction of a color signal processing apparatus of a second embodiment of the present invention. In the first embodiment, approximate expressions are made use of in the entire range of a specific color, but in contrast to this, in the second embodiment, only in cases where the value of a specific color is within a predetermined range, the coefficients calculated from approximate expressions are used, and in the other cases, fixed coefficients are used. It is preferable that “the predetermined range” be set to include a region where the change of a linear matrix coefficient is particularly large, among the range or gamut of the specific color (the range or gamut of the first color). In the case of a display device with a characteristic shown in FIG. 9, it is only needed to set a region in which the signal value of a specific color is small (a part of the region at a low brightness side) as the predetermined range.

The color signal processing apparatus of this second embodiment is provided with, in addition to the construction of the first embodiment, a linear matrix selection unit 201, a constant unit 202, and a fixed linear matrix coefficient unit 203. The constant unit 202 is a memory that stores a constant which specifies a range in which a linear matrix coefficient calculated from an approximate expression is used. When using an approximate expression in cases where the value of a specific color is in the range of 0 through 102, as shown in FIG. 10, a value “102” is stored in the constant unit 202. The fixed linear matrix coefficient unit 203 is a memory that stores a fixed linear matrix coefficient, and corresponds to a fixed matrix coefficient storage unit of the present invention. As the value of the fixed linear matrix coefficient, an average of the coefficient values in the range of 103 through 255 in FIG. 9 may be used, for example. Here, note that a linear matrix coefficient in the range of 0 through 102 can be approximated to a sufficient extent by a second-order polynomial, as mentioned above, so three approximate coefficients in the second-order polynomial are stored in the approximate coefficient storage unit 105.

The value of the B signal in the input RGB color signal 101 is also transmitted to the linear matrix selection unit 201. The linear matrix selection unit 201 makes a comparison between the value of the B signal with the constant read out from the constant unit 202. When the value of the B signal is larger than this constant, the linear matrix selection unit 201 reads out the fixed linear matrix coefficient from the fixed linear matrix coefficient unit 203. On the other hand, in cases where the value of the B signal is equal to or less than this constant, the linear matrix selection unit 201 reads out the linear matrix coefficients calculated in the linear matrix coefficient calculation unit 104, as in the case of the first embodiment. The linear matrix operation unit 103 performs color conversion with the use of the linear matrix coefficients received from the linear matrix selection unit 201.

According to the construction of this second embodiment, each linear matrix coefficient can be defined by a second-order polynomial, so it is possible to reduce the circuit scales of the linear matrix coefficient calculation unit 104 and the approximate coefficient storage unit 105, as compared with the first embodiment.

### Third Embodiment

As can be understood from FIG. 6, the change of a chromaticity point is also seen for any of the primary colors of RGB. Accordingly, in the above-mentioned embodiments, even if any of the primary colors is selected as a “specific color”, a proper effect is obtained.

However, the above-mentioned effect is obtained most notably in the case where the one, among the three primary colors of RGB, of which a monochromatic chromaticity change due to a change of the signal value is most perceived by an observer is selected as a “specific color”. Accordingly, in a third embodiment, by making a comparison among the individual chromaticity changes of RGB, the color of which the monochromatic chromaticity change is most perceived is selected as a specific color. The other construction is the same as that of the above-mentioned embodiments. Here, for the purpose of evaluation of the chromaticity change, there can also be used, for example, color differences based on the CIE 1976 UCS chromaticity diagram, or the CIE 2000 color difference formula, or the results of subjective evaluation experiments.

### Fourth Embodiment

In the above-mentioned embodiments, the chromaticity changes of the primary colors other than the specific color are not corrected. However, the influence of the chromaticity change of a primary color other than the specific color on color conversion accuracy may not be able to be ignored. In such a case, in order to suppress the chromaticity change of a primary color (hereinafter referred to as a “second color”) other than the specific color (i.e., other than the first color), there can be made use of a construction for chromaticity stabilization as proposed in the above-mentioned Japanese patent application laid-open No. 2005-354728, which is incorporated herein by reference.

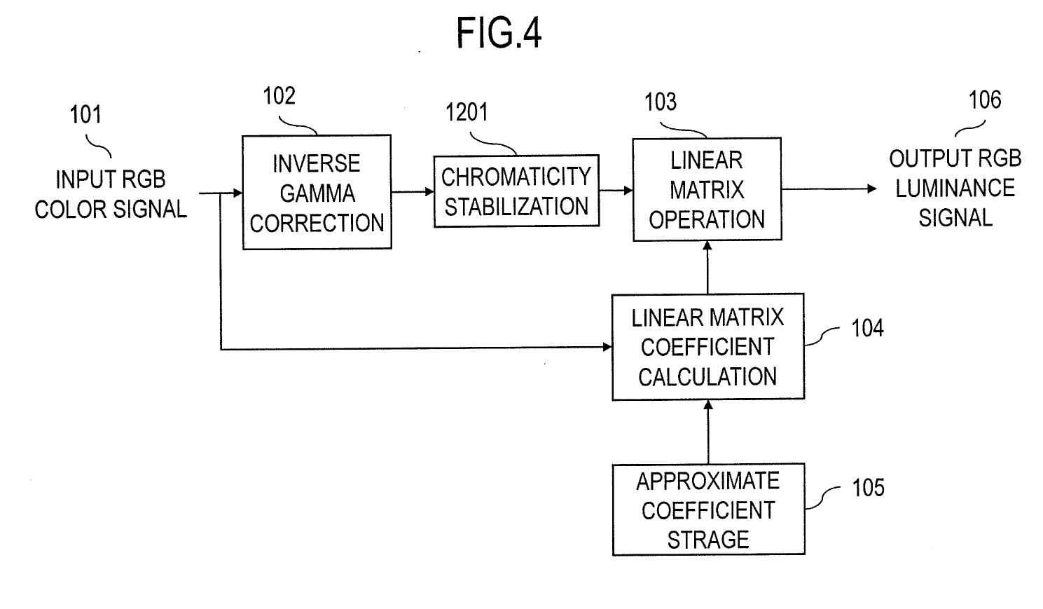

In FIG. 4, there is shown a construction in which a chromaticity stabilization unit 1201 is added to the color signal processing apparatus of the first embodiment. The chromaticity stabilization unit 1201 is a block which corresponds to a chromaticity point correction unit 811 in the Japanese patent application laid-open No. 2005-354728. The principle of the chromaticity stabilization unit 1201 is to cancel an amount of chromaticity change due to a change in the value of the second color by adjusting (i.e., increasing or decreasing) the signal value(s) of the primary color(s) (one color or two colors) other than the second color, thereby to apparently remove the chromaticity change of the second color. For example, in cases where the chromaticity of an R primary color as a second color is corrected, the chromaticity stabilization unit 1201 decides an adjustment value(s) for a G signal and/or a B signal according to the value of an R signal in an input RGB signal, and adds the adjustment value(s) to the G signal and/or B signal. In cases where the value of the G signal or the B signal is decreased, the adjustment value becomes minus or negative. Here, note that the calculation of the adjustment value(s) may use a table in which the R signal value and the adjustment value (s) are associated with each other, or may use a function (formula).

According to the construction of this fourth embodiment, the chromaticity of the second color can be apparently fixed, although the color gamut thereof becomes narrow. Accordingly, it is possible to achieve color conversion with higher precision while maintaining the advantage of being able to make use of the largest color gamut for the specific color.

### Fifth Embodiment

In the above-mentioned fourth embodiment, the chromaticity of at least one primary color other than the specific color is corrected. However, the changes of the chromaticities of primary colors other than the specific color can be practically ignored in many cases. In such cases, the first through third embodiments can be applied in a preferable manner.

In the constructions of the above-mentioned first through third embodiments, approximate coefficients need only be created, while regarding the chromaticities of primary colors other than the specific color as fixed values. At this time, it is appropriate to select, as the chromaticity of each primary color other than the specific color, the chromaticity value of the primary color at the time when the brightness thereof becomes the highest. This is because human color discrimination ability is higher in a bright place than in a dark place. Thus, by setting the chromaticities of primary colors other than the specific color in this manner, there is also provided an effect that the scale or size of circuitry can be made small.

<Other Modifications>

The present invention is not limited to the constructions of the above-mentioned embodiments, but can be changed or modified in a variety of ways as appropriate within the scope of its technical concept. For example, the same modification as that of the first embodiment can be made to the second through fifth embodiments.

The present invention can be applied to a system which is composed of a plurality of equipment (for example, a computer main body and a display device, a broadcast receiver and a display device, etc.), or can also be applied to a device consisting of a single equipment (for example, a display device, a TV device, etc.).

In addition, the object of the present invention is also achieved by supplying to the system a storage medium which has recorded thereon the code of a computer program to implement the functions stated above, so that the code of the computer program is read out and executed by means of the system. In this case, the code of the computer program read out of the storage medium itself achieves the functions of the above-mentioned embodiments, and the storage medium with the code of the computer program stored thereon constitutes the present invention. Moreover, the present invention also includes a case in which an operating system (OS), etc., which works on a computer, carries out part or all of actual processing based on instructions of the program cord, so that the above-mentioned functions are achieved by that processing.

Further, the present invention may be achieved by the following form. That is, the code of a computer program read out of a storage medium is written into a memory provided in a function expansion card which has been inserted into a computer, or a memory provided in a function expansion unit which has been connected to a computer. Then, a CPU, etc., which is provided in the function expansion card or the function expansion unit, carries out part or all of actual processing based on instructions of the code of the computer program, thereby achieving the above-mentioned functions. Such a case is also included in the present invention.

In cases where the present invention is applied to the above-mentioned storage medium, the code of the computer program previously explained is stored in the storage medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-92540, filed on Apr. 13, 2010, which is hereby incorporated by reference herein in its entirety.

What is claimed is:

1. A color signal processing apparatus which performs a linear matrix transformation, comprising:
an approximate coefficient storage unit that stores approximate coefficients of approximate expressions, which approximate values of the matrix coefficients, respectively, and in which a value of a first color among three primary colors of RGB is made a variable,
a matrix coefficient calculation unit that calculates 3×3 matrix coefficients according to an input RGB signal by substituting a value of the first color in the input RGB signal for the approximate expressions given by the approximate coefficients read out from the approximate coefficient storage unit; and
a conversion unit that performs color conversion by multiplying the input RGB signal by the matrix coefficients calculated by the matrix coefficient calculation unit, and outputs color-converted RGB signal.

2. The color signal processing apparatus according to claim 1, further comprising:
a fixed matrix coefficient storage unit that stores fixed matrix coefficients,
wherein the conversion unit uses the matrix coefficients calculated by the matrix coefficient calculation unit only in cases where the value of the first color in the input RGB signal is within a predetermined range, and uses, in the case of others, the fixed matrix coefficients read out of the fixed matrix coefficient storage unit.

3. The color signal processing apparatus according to claim 2, wherein
the predetermined range is a part of a gamut of the first color at a low brightness side.

4. The color signal processing apparatus according to claim 1, wherein
the first color is a color, among the three primary colors of RGB, in which a chromaticity change in a single color due to a change in a value thereof is most perceived by an observer.

5. The color signal processing apparatus according to claim 1, further comprising:
a chromaticity stabilization unit that, with respect to a second color other than the first color among the three primary colors of RGB, adds an adjustment value, which is determined according to a value of the second color in the input RGB signal, to a value of at least one color other than the second color, in order to suppress a change in chromaticity of the second color due to a change in a value thereof.

6. The color signal processing apparatus according to claim 1, wherein
the approximate coefficients stored in the approximate coefficient storage unit are calculated by using, as chromaticity values of two primary colors other than the first color among the three primary colors of RGB, a chromaticity value at the time when the brightness of each primary color becomes the highest.

7. A color signal processing method which performs a linear matrix transformation, comprising the steps of:
reading out approximate coefficients of approximate expressions, which approximate values of the matrix coefficients, respectively, and in which a value of a first color among three primary colors of RGB is made a variable, from an approximate coefficient storage unit that stores the approximate coefficients;
calculating 3×3 matrix coefficients according to an input RGB signal by substituting a value of the first color in the input RGB signal for the approximate expressions given by the approximate coefficients read out; and
performing color conversion by multiplying the input RGB signal by the calculated matrix coefficients, and to output color-converted RGB signal.

8. A non-transitory computer readable medium which stores a program for making a computer execute each step of the color signal processing method according to claim 7.
